(19) United States
(12) Patent Application Publication
(10) Pub. No.: US 2025/0243059 A1
(43) Pub. Date: Jul. 31, 2025

(54) POWDER INCLUDING SPECIFIC BORON NITRIDE PARTICLES, HEAT DISSIPATION SHEET, AND METHOD FOR PRODUCING HEAT DISSIPATION SHEET

(71) Applicant: Denka Company Limited, Chuo-ku, Tokyo (JP)

(72) Inventors: Mana YAMAMOTO, Chuo-ku, Tokyo (JP); Kenji MIYATA, Chuo-ku, Tokyo (JP); Yusuke SASAKI, Chuo-ku, Tokyo (JP)

(73) Assignee: Denka Company Limited, Chuo-ku, Tokyo (JP)

(21) Appl. No.: 18/687,278

(22) PCT Filed: Aug. 31, 2022
(86) PCT No.: PCT/JP2022/032747

§ 371 Date: Feb. 27, 2024

(30) Foreign Application Priority Data
Aug. 31, 2021 (JP) 2021-141701

(51) Int. Cl. C01B 21/064

(52) U.S. Cl. CPC C01B 21/064; C01P 2004/03; C01P 2004/12; C01P 2004/50; C01P 2006/21

(57) ABSTRACT

A powder containing a tubular boron nitride particle and an aggregated boron nitride particle that is an aggregate of a plurality of boron nitride primary particles, the aggregated boron nitride particle having a crushing strength of less than 7 MPa. A method for producing a heat dissipation sheet, the method including a step of applying a pressure to a composition to form into a sheet shape, the composition comprises a tubular boron nitride particle, an aggregated boron nitride particle that is an aggregate of a plurality of boron nitride primary particles and a resin, the aggregated boron nitride particle having a crushing strength of less than 7 MPa. A heat dissipation sheet containing a tubular boron nitride particle, a plurality of boron nitride primary particles and a resin, in which some of the plurality of boron nitride primary particles are located within the tubular boron nitride particle.

### TECHNICAL FIELD

The present invention relates to a powder including specific boron nitride particles, a heat dissipation sheet, and a method for producing a heat dissipation sheet.

### BACKGROUND ART

In electronic components such as power devices, transistors, thyristors and CPUs, there is a problem with efficient dissipation of heat that is generated during use. Regarding this problem, heat dissipation members containing a ceramic powder having a high thermal conductivity are in use.

As the ceramic powder, a boron nitride powder having characteristics such as high thermal conductivity, high insulating properties and a low relative permittivity is gaining attention. The boron nitride powder is usually composed of aggregated particles that are formed by aggregation of the primary particles of boron nitride. For example, Patent Literature 1 discloses a hexagonal boron nitride powder in which the shape of an aggregated particle is made to be more spherical to enhance the filling properties and improve the powder strength and, furthermore, which is considered to improve the insulating properties and stabilize the voltage resistance of heat transfer sheets filled with the powder by improving the purity.

### CITATION LIST

### Patent Literature

[Patent Literature 1] Japanese Unexamined Patent Publication No. 2011-98882

### SUMMARY OF INVENTION

### Technical Problem

In the case of using the hexagonal boron nitride powder as described in Patent Literature 1, the thermal conductivity of a heat dissipation sheet relies on the shape, size, strength or the like of the aggregated particle. Conversely, once the shape, size, strength or the like of the aggregated particle is determined, the thermal conductivity of a heat dissipation sheet for which the aggregated particle is used is also approximately determined, and there is a limit to enhancement of the thermal conductivity of a heat dissipation sheet with one kind of hexagonal boron nitride powder.

Therefore, a primary objective of the present invention is to provide a powder capable of more effectively improving the thermal conductivity of a heat dissipation sheet than a boron nitride powder composed of one kind of aggregated boron nitride particle.

### Solution to Problem

One aspect of the present invention is a powder containing a tubular boron nitride particle and an aggregated boron nitride particle that is an aggregate of a plurality of boron nitride primary particles, in which the aggregated boron nitride particle has a crushing strength of less than 7 MPa.

As a result of the present inventors' studies, it has been clarified that the use of a tubular boron nitride particle in addition to an aggregated boron nitride particle makes improvement in the thermal conductivity of a heat dissipation sheet expected and, furthermore, the use of an aggregated boron nitride particle having a relatively low crushing strength as the aggregated boron nitride particle makes it possible to more effectively improve the thermal conductivity of the heat dissipation sheet.

In the powder, a content of the tubular boron nitride particle may be 2 to 26 vol % based on a total volume of the powder.

In the powder, the tubular boron nitride particle may include a boron nitride particle having a maximum length of 80 μm or more and an aspect ratio of 1.5 or more.

In the powder, the tubular boron nitride particle may have a strength of 25 mN or more.

Another aspect of the present invention is a method for producing a heat dissipation sheet, the method including a step of applying a pressure to a composition to form into a sheet shape, in which the composition comprises a tubular boron nitride particle, an aggregated boron nitride particle that is an aggregate of a plurality of boron nitride primary particles and a resin, in which the aggregated boron nitride particle has a crushing strength of less than 7 MPa.

Still another aspect of the present invention is a heat dissipation sheet containing a tubular boron nitride particle, a plurality of boron nitride primary particles and a resin, in which some of the plurality of boron nitride primary particles is located within the tubular boron nitride particle.

In the heat dissipation sheet, having an orientation index of 7 to 15.

In the heat dissipation sheet, the tubular boron nitride particle may include a boron nitride particle having a maximum length of 80 μm or more and an aspect ratio of 1.5 or more.

### Advantageous Effects of Invention

According to the present invention, it is possible to provide a powder capable of more effectively improving the thermal conductivity of a heat dissipation sheet than a boron nitride powder composed of one kind of aggregated boron nitride particle.

### BRIEF DESCRIPTION OF DRAWINGS

FIG. 1 is a SEM image of tubular boron nitride particles fabricated in Example 1.

FIG. 2 is a SEM image of a cross section of a heat dissipation sheet fabricated in Example 1.

FIG. 3 is a SEM image of a cross section of a heat dissipation sheet fabricated in Comparative Example 1.

### DESCRIPTION OF EMBODIMENTS

Hereinafter, embodiments of the present invention will be described in detail.

One embodiment of the present invention is a powder containing a tubular boron nitride particle and an aggregated boron nitride particle that is an aggregate of a plurality of boron nitride primary particles.

The tubular boron nitride particle has an elongated shape. The tubular boron nitride particle has an outer shell part formed of boron nitride and a hollow part surrounded by the outer shell part. The hollow part may be formed along the longitudinal direction of the tubular boron nitride particle or may have an elongated shape that is approximately similar to the external shape of the tubular boron nitride particle. At least one of both ends of the tubular boron nitride particle in the longitudinal direction is an open end and communicates with the hollow part. Both ends of the tubular boron nitride may be all open ends.

The tubular boron nitride particle may be composed of a plurality of boron nitride pieces. The boron nitride piece is formed of boron nitride and may have, for example, a scaly shape. In this case, the length of the boron nitride piece in the longitudinal direction may be, for example, 1 μm or more and 10 μm or less. The plurality of boron nitride pieces composing the tubular boron nitride particle may be in physical contact with one another or may be chemically bonded to one another.

The maximum length of the tubular boron nitride particle may be 80 μm or more, 100 μm or more, 125 μm or more, 150 μm or more, 175 μm or more, 200 μm or more, 225 μm or more, 250 μm or more, 300 μm or more or 350 μm or more from the viewpoint of more easily improving the thermal conductivity of a heat dissipation sheet. The maximum length of the tubular boron nitride particle may be 1000 μm or less, 500 μm or less, 300 μm or less or 250 μm or less.

The maximum length of the tubular boron nitride particle means the length of the maximum distance among the straight distances between two arbitrary points on one tubular boron nitride particle when the tubular boron nitride particle has been observed with a scanning electron microscope (SEM). The maximum length may be measured by importing an observation image (SEM image) of the tubular boron nitride particle into image analysis software (for example, “Mac-view” manufactured by Mountech Co., Ltd.).

The aspect ratio of the tubular boron nitride particle may be 1.5 or more, 1.7 or more, 2.0 or more, 2.2 or more, 2.5 or more, 3.0 or more, 5.0 or more or 7.0 or more from the viewpoint of more easily improving the thermal conductivity of a heat dissipation sheet. The aspect ratio of the tubular boron nitride particle may be 12.0 or less, 10.0 or less, 9.5 or less, 9.0 or less, 8.0 or less, 7.0 or less, 6.0 or less, 5.0 or less, 4.0 or less, 3.0 or less, 2.8 or less or 2.6 or less.

The aspect ratio of the tubular boron nitride particle is defined as the ratio (L_{A}/L_{B}) between the above-described maximum length of the tubular boron nitride particle (maximum length in the longitudinal direction) L_{A} and the maximum length of the tubular boron nitride particle in a direction (lateral direction) L_{B} perpendicular to the direction of the maximum length L_{A} (longitudinal direction). The maximum length L_{B} in the lateral direction can be measured by the same method for the maximum length L_{A} in the longitudinal direction.

The thickness of the outer shell part of the tubular boron nitride particle may be 50 μm or less, 30 μm or less, 15 μm or less, 10 μm or less or 8 μm or less. The thickness of the outer shell part may be 1 μm or more, 3 μm or more or 5 μm or more from the viewpoint of easily maintaining the shape of the tubular boron nitride particle. The thickness of the outer shell part is defined as the average value of the lengths of parts in the outer shell part where a straight line has been drawn when the straight lines have been drawn on a cross section of the tubular boron nitride particle such that the straight distance between two arbitrary points was maximized on an observation image (SEM image) obtained by observing the cross section in a direction perpendicular to the longitudinal direction of the tubular boron nitride particle with SEM.

The external shape of the tubular boron nitride particle may be a columnar shape (rod shape), a pyramidal shape (a conic shape or the like) or the like and may be a bent shape. The tubular boron nitride particle may a branched structure that is branched in two or more directions.

The strength of the tubular boron nitride particle may be 25 mN or more, 26 mN or more, 28 mN or more, 30 mN or more, 32 mN or more, 35 mN or more, 38 mN or more or 40 mN or more from the viewpoint of making it more difficult for the tubular boron nitride particle to collapse during the forming of a heat dissipation sheet and further improving the thermal conductivity of the heat dissipation sheet. The strength of the tubular boron nitride particle may be 60 mN or less, 55 mN or less, 53 mN or less, 50 mN or less, 48 mN or less, 45 mN or less or 42 mN or less. The strength of the tubular boron nitride particle can be calculated from the average value of the intensities of loads necessary to collapse tubular boron nitride particles when 10 tubular boron nitride particles have been collapsed with a micro compression testing machine. More specifically, first, 10 or more tubular boron nitride particles that are selected from the powder are installed on a specimen support. At this time, the tubular boron nitride particles are installed in a manner that the longitudinal direction of each tubular boron nitride particle is along the installation surface of the specimen support. Subsequently, the indenter (for example, the indenter diameter is 200 μm) of a micro compression testing machine (for example, MCT series manufactured by Shimadzu Corporation) is lowered toward one tubular boron nitride particle on the specimen support to apply a load at a loading rate of 0.27 mN/second. In addition, the intensity of the load when the displacement amount of the tubular boron nitride particle in the lateral direction abruptly increases is measured as the intensity of a load necessary to collapse the tubular boron nitride particle. This measurement is performed in the same manner on the 10 tubular boron nitride particles, and the strength of the tubular boron nitride particle is calculated as the average value of the intensities of the loads for the 10 tubular boron nitride particles.

The tubular boron nitride particle may be a boron nitride particle that returns to a shape close to the original shape upon unloading even after deformed due to a load applied from the outside (elastic boron nitride particle). The fact that the tubular boron nitride particle is an elastic boron nitride particle can be confirmed from the fact that, for example, when the tubular boron nitride particle has been subjected to a loading and unloading test including a loading step of compressing the tubular boron nitride particle by slowly applying a load from 0.2 mN up to 20 mN at a loading rate of 0.27 mN/seconds in the lateral direction and an unloading step of slowly removing the load to 0.2 mN at an unloading rate of 0.27 mN/seconds in this order, at least a part of the length in the lateral direction of the tubular boron nitride particle compressed in the loading step is returned in the unloading step. It is considered that, when the tubular boron nitride particle is an elastic boron nitride particle, it is easier to maintain a heat conduction path in a heat dissipation sheet even after a pressure or stress is applied to the tubular boron nitride particle, and the tubular boron nitride particle is thus preferably an elastic boron nitride particle.

The content of the tubular boron nitride particle may be 2 vol % or more, 4 vol % or more, 6 vol % or more, 8 vol % or more or 10 vol % or more based on the total volume of the powder. The content of the tubular boron nitride particle may be 26 vol % or less, 24 vol % or less, 22 vol % or less, 20 vol % or less, 18 vol % or less, 16 vol % or less, 14 vol % or less or 12 vol % or less based on the total volume of the powder. The content of the tubular boron nitride particle may be 2 to 26 vol % based on the total volume of the powder.

The tubular boron nitride particle can be obtained by, for example, generating a boron nitride particle on a carbon sheet by a production method including a step of obtaining a mixture by mixing 2 to 100 parts by mass of boric acid with 100 parts by mass of a boron carbide powder having an average particle diameter of 5 to 100 μm, a step of filling a carbon crucible with the mixture and a step of heating the lidded carbon crucible in a resistance heating furnace in a nitrogen gas atmosphere under conditions of 1450° C. to 2400° C. and 0.3 to 1.0 MPa for three to 40 minutes in a state where the open part of the carbon crucible has been covered with the carbon sheet and the carbon sheet has been sandwiched by the lid of the carbon crucible and the carbon crucible to fix the carbon sheet and collecting the boron nitride particle generated on the carbon sheet. On the obtained tubular boron nitride particle, pulverization, sieving, washing, impurity removal, drying or the like may be performed as appropriate.

The aggregated boron nitride particle is an aggregate of a plurality of boron nitride primary particles, and the plurality of boron nitride primary particles may be in physical contact with one another. The boron nitride primary particle may be formed of boron nitride and may have, for example, a scaly shape. In this case, the length of the boron nitride primary particle in the longitudinal direction may be, for example, 1 μm or more and may be 10 μm or less.

The average particle diameter of the aggregated boron nitride particle may be 30 μm or more, 50 μm or more, 60 μm or more, 70 μm or more or 80 μm or more. The average particle diameter of the aggregated boron nitride particle may be, for example, 200 μm or less, 150 μm or less, 120 μm or less, 100 μm or less, 90 μm or less, 80 μm or less, 70 μm or less, 60 μm or less, 50 μm or less or 40 μm or less. The average particle diameter of the aggregated boron nitride particle is the d50 diameter in the volume-based particle size distribution and can be measured with a laser diffraction-type particle size distribution measuring instrument.

The aspect ratio of the aggregated boron nitride particle may be 1.0 or more, 1.1 or more or 1.2 or more. The aspect ratio of the aggregated boron nitride particle may be, for example, 5.0 or less, 3.0 or less, 2.0 or less or 1.5 or less. The aspect ratio of the aggregated boron nitride particle is defined as the ratio (L_{C}/L_{D}) between the maximum length of the aggregated boron nitride particle (maximum length in the longitudinal direction) L_{C} and the maximum length of the aggregated boron nitride particle in a direction (lateral direction) perpendicular to the direction of the maximum length L_{C} (longitudinal direction) L_{D}. The maximum length L_{C} in the longitudinal direction and the maximum length L_{D} in the lateral direction of the aggregated boron nitride particle can be measured by the same method for the maximum length L_{A} in the longitudinal direction and the maximum length L_{B} in the lateral direction of the tubular boron nitride particle.

The crushing strength of the aggregated boron nitride particle may be less than 7 MPa, 6 MPa or less, 5 MPa or less or 4 MPa or less from the viewpoint of making it more difficult for the tubular boron nitride particle to collapse during the forming of a heat dissipation sheet. The crushing strength of the aggregated boron nitride particle may be 1 MPa or more, 2 MPa or more or 3 MPa or more. The crushing strength of the aggregated boron nitride particle means the average value of the crushing strengths of 10 aggregated boron nitride particles that are measured according to JIS R1639-5:2007 (also referred to as the particle strength or compressive strength of a single granule). More specifically, the crushing strength (σ: unit MPa) of each aggregated boron nitride particle is calculated using a formula σ=a×P/(π×d²) from a dimensionless number (a=2.48: no unit) that changes depending on the position in the particle, the crushing test force (P: unit N) and the particle diameter (d: unit μm). The crushing strength of the aggregated boron nitride particle is calculated as the average value of the crushing strengths of 10 aggregated boron nitride particles.

The content of the aggregated boron nitride particle may be 74 vol % or more, 76 vol % or more, 78 vol % or more, 80 vol % or more, 82 vol % or more, 84 vol % or more, 86 vol % or more, 88 vol % or more or 90 vol % or more based on the total volume of the powder. The content of the aggregated boron nitride particle may be 98 vol % or less, 96 vol % or less, 94 vol % or less, 92 vol % or less or 90 vol % or less based on the total volume of the powder.

The aggregated boron nitride particle can be obtained by, for example, a production method including a step of nitriding a boron carbide powder to obtain a boron carbonitride powder and a step of decarburizing the boron carbonitride powder to obtain an aggregated boron nitride particle. On the obtained aggregated boron nitride particle, pulverization, sieving, washing, impurity removal, drying or the like may be performed as appropriate.

The tubular boron nitride particle and the aggregated boron nitride particle may be substantially composed of boron nitride alone. The fact that the tubular boron nitride particle and the aggregated boron nitride particle are substantially composed of boron nitride alone can be confirmed from the fact that only a peak derived from boron nitride is detected in X-ray diffraction measurement.

The powder according to one embodiment is capable of more effectively improving the thermal conductivity of a heat dissipation sheet when the tubular boron nitride particle and an aggregated boron nitride particle having a relatively low crushing strength are jointly used compared with a case where the tubular boron nitride particle and an aggregated boron nitride particle having a relatively high crushing strength are jointly used. The reason therefor is presumed as described below. First, it is considered that the tubular boron nitride particle has an elongated shape, whereby the thermal conductivity in the longitudinal direction of the tubular boron nitride particle is excellent. In a case where an aggregated boron nitride particle having a relatively low crushing strength is used, when a pressure is applied to the tubular boron nitride particle and the aggregated boron nitride particle during the forming of a heat dissipation sheet, the aggregated boron nitride particle having a relatively low crushing strength is more likely to collapse than the tubular boron nitride particle. In addition, the collapsed boron nitride primary particle plays a role of a cushioning material, whereby the shape of the tubular boron nitride particle is likely to be maintained even in a case where a pressure is applied to the tubular boron nitride particle. Therefore, it is presumed that, in an obtained heat dissipation sheet, a heat conduction path is likely to be formed by the tubular boron nitride particle and the thermal conductivity improves.

The powder according to one embodiment may further contain a different inorganic particle in addition to the tubular boron nitride particle and the aggregated boron nitride particle. Examples of the different inorganic particle include a boron nitride particle that corresponds to neither the tubular boron nitride particle nor the aggregated boron nitride particle, an alumina particle, an aluminum nitride particle, a silicon carbide particle and the like.

The powder containing the tubular boron nitride particle and the aggregated boron nitride particle is used in a composition mixed with a resin. When this composition is formed into a sheet shape by applying a pressure thereto, a heat dissipation sheet is obtained. That is, another embodiment of the present invention is a composition containing the tubular boron nitride particle, the aggregated boron nitride particle and a resin. In addition, still another embodiment of the present invention is a method for producing a heat dissipation sheet including a step of applying a pressure to a composition to form into a sheet shape, in which the composition comprises a tubular boron nitride particle, an aggregated boron nitride particle that is an aggregate of a plurality of boron nitride primary particles and a resin.

The resin may be, for example, a silicone resin, an epoxy resin, silicone rubber, an acrylic resin, a phenolic resin, a melamine resin, a urea resin, unsaturated polyester, a fluororesin, polyimide, polystyrene, polyolefin, polyamide, polyamide imide, polyether imide, polybutylene terephthalate, polyethylene terephthalate, polyphenylene ether, polyphenylene sulfide, fully aromatic polyester, polysulfone, a liquid crystalline polymer, polyether sulfone, polycarbonate, a maleimide-modified resin, an ABS (acrylonitrile-butadiene-styrene) resin, an AAS (acrylonitrile-acrylic rubber/styrene) resin or an AES (acrylonitrile/ethylene/propylene/diene rubber-styrene) resin.

The weight-average molecular weight of the resin may be 1000 to 1000000 or 2000 to 800000. The weight-average molecular weight of the resin can be measured by measurement by gel permeation chromatography (GPC) and polystyrene conversion.

The content of the resin may be 15 vol % or more, 20 vol % or more, 30 vol % or more, 40 vol % or more, 50 vol % or more or 60 vol % or more and may be 80 vol % or less, 70 vol % or less, 60 vol % or less, 50 vol % or less or 40 vol % or less based on the total volume of the composition.

The content of the tubular boron nitride particle in the composition may be 1 vol % or more, 2 vol % or more, 3 vol % or more or 5 vol % or more and may be 10 vol % or less, 9 vol % or less, 8 vol % or less, 7 vol % or less, 6 vol % or less or 5 vol % or less based on the total volume of the composition.

The content of the aggregated boron nitride particle in the composition may be 40 vol % or more, 42 vol % or more, 43 vol % or more or 45 vol % or more and may be 55 vol % or less, 54 vol % or less, 53 vol % or less or 50 vol % or less based on the total volume of the composition.

The content of the above-described powder in the composition may be 45 vol % or more, 46 vol % or more, 47 vol % or more or 50 vol % or more and may be 60 vol % or less, 58 vol % or less, 57 vol % or less, 55 vol % or less, 53 vol % or less, 51 vol % or less or 50 vol % or less based on the total volume of the composition.

The composition may further contain a different component other than the resin. The different component may be a monomer, a solvent, a coupling agent, a curing agent, a curing accelerator (curing catalyst), a wetting and dispersing agent, a surface conditioning agent, an addition reaction catalyst, an organic particle, a pigment or the like.

The monomer may be a monomer having a polymerizable carbon-carbon double bond. The monomer may be, for example, a monomer having an acryloyl group, a methacryloyl group, an allyl group, a methallyl group or a vinyl group. The monomer may be, for example, acrylic acid, methacrylic acid, crotonic acid, 2-pentenoic acid, maleic acid, fumaric acid, itaconic acid, cinnamic acid, maleic acid monoalkyl ester, fumaric acid monoalkyl ester, monocyclohexyl maleate, monocyclohexyl fumarate, glycidyl acrylate, glycidyl methacrylate, allyl glycidyl ether, methallyl glycidyl ether, methyl acrylate, ethyl acrylate, butyl acrylate, 2-chloroethyl acrylate, methyl methacrylate, ethyl methacrylate, butyl methacrylate, 2-chloroethyl methacrylate, 2-chloroethyl vinyl ether, vinylbenzyl chloride, vinyl chloroacetate, allyl chloroacetate or diallyl fumarate.

Examples of the solvent include alcoholic solvents, glycol ether-based solvents, aromatic solvents, ketone-based solvents and the like. Examples of the alcoholic solvents include isopropyl alcohol, diacetone alcohol and the like. Examples of the glycol ether-based solvents include ethyl cellosolve, butyl cellosolve and the like. Examples of the aromatic solvents include toluene, xylene and the like. Examples of the ketone-based solvents include methyl ethyl ketone, methyl isobutyl ketone and the like.

The coupling agent may be a silane coupling agent. The silane coupling agent may be a silane coupling agent having a reactive double bond or may be a silane coupling agent having a vinyl group, an allyl group or the like. Examples of the silane coupling agent include allyltriethoxysilane, allylchlorodimethylsilane, allyltrimethoxysilane, allyltrichlorosilane, chlorodimethylvinylsilane, diethoxymethylvinylsilane, dimethoxymethylvinylsilane, trichlorovinylsilane, vinyltrimethoxysilane, dimethylethoxyvinylsilane, vinyltris(2-methoxyethoxy) silane and the like.

Examples of the curing agent include phenol novolac compounds, acid anhydrides, amino compounds, imidazole compounds and the like.

Examples of the curing accelerator (curing catalyst) include phosphorous curing accelerators such as tetraphenylphosphonium tetraphenylborate and triphenyl phosphate, imidazole-based curing accelerators such as 2-phenyl-4,5-dihydroxymethylimidazole, amine-based curing accelerators such as boron trifluoride monoethylamine and the like.

Examples of the wetting and dispersing agent include phosphoric acid ester salts, carboxylic acid esters, polyesters, acrylic copolymers, block copolymers and the like.

Examples of the surface conditioning agent include acrylic surface conditioning agents, silicone-based surface conditioning agents, vinyl-based surface conditioning agent, fluorine-based surface conditioning agent and the like.

The composition can be prepared by mixing the above-described powder and resin and other components that are used as necessary by a well-known method (for example, kneading with a Henschel mixer).

In the step of applying a pressure to a composition to form into a sheet shape (forming step), for example, the composition is applied onto a base material using a film applicator, and a pressure is applied thereto, whereby the composition can be formed into a sheet shape. In the forming step, the composition may be heated at the same time as the application of a pressure to the composition. In the forming step, a step of curing part or all of the resin in the composition (curing step) may be performed at the same time as forming or after forming.

From the viewpoint of retaining the shape of the tubular boron nitride particle while collapsing the aggregated boron nitride particle, the pressure that is applied in the forming step may be 7 MPa or more, 8 MPa or more, 10 MPa or more or 12 MPa or more and may be 16 MPa or less, 12 MPa or less or 10 MPa or less.

In a case where the composition contains a curable component (a thermosetting or photocurable resin, monomer or the like), a method for curing the resin in the composition can be selected as appropriate depending on the kind of the resin and/or the monomer that is contained in the composition. For example, in a case where the resin is an epoxy resin and the above-described curing agent is used together, the resin can be cured by heating.

In a heat dissipation sheet that is obtained as described above, since the aggregated boron nitride particle having a relatively low crushing strength collapses more preferentially than the tubular boron nitride particle at the time of forming the composition into a sheet shape, the boron nitride particle primary particles of the collapsed aggregated boron nitride particle are located within the tubular boron nitride particle. That is, another embodiment of the present invention is a heat dissipation sheet containing a tubular boron nitride particle, a plurality of boron nitride primary particles and a resin.

The plurality of boron nitride primary particles may be formed of boron nitride and may have, for example, a scaly shape. In this case, the length of the boron nitride primary particle in the longitudinal direction may be, for example, 1 μm or more and 10 μm or less.

Some of the plurality of boron nitride primary particles are located within the tubular boron nitride particle. The fact that some of the plurality of boron nitride primary particles are located within the tubular boron nitride particle (in the hollow part of the tubular boron nitride particle) in the heat dissipation sheet can be confirmed by observing a cross section of the heat dissipation sheet with SEM. In a case where the outer shell part of the tubular boron nitride particle has no openings (forms a closed space) in a cross-sectional image (SEM image) of the heat dissipation sheet, the inside of the tubular boron nitride particle means the inside of the closed space of the tubular boron nitride particle. In addition, in a case where the outer shell part of the tubular boron nitride particle has an opening in a cross-sectional image (SEM image) of the heat dissipation sheet, the inside of the tubular boron nitride particle means the inside of a part that is surrounded by a straight line that connects the ends of the tubular boron nitride particle in the opening and the outer shell part of the tubular boron nitride particle. The straight line that connects the ends of the tubular boron nitride particle in the opening is a straight line that connects the ends so that the area of the hollow part of the tubular boron nitride particle is maximized.

The remainder of the plurality of boron nitride primary particles, that is, boron nitride primary particles other than the boron nitride primary particles in the tubular boron nitride particle (boron nitride primary particles outside the tubular boron nitride particle), is present throughout the entire heat dissipation sheet. Some of the boron nitride primary particles outside the tubular boron nitride particle may form a lumpy shape (the shape of part or all of the aggregated boron nitride particle, which is a raw material, may be maintained). In other words, the heat dissipation sheet may contain an aggregated boron nitride particle that is an aggregate of the plurality of boron nitride primary particles.

In a case where the heat dissipation sheet contains the aggregated boron nitride particle, since it is difficult to distinguish the grain boundary between the aggregated boron nitride particles from an observation image (SEM image) of a cross section of the heat dissipation sheet, it is difficult to confirm the fact that the heat dissipation sheet contains the aggregated boron nitride particle, but the fact that the heat dissipation sheet contains the aggregated boron nitride particle can be confirmed by the following method.

First, the heat dissipation sheet is placed on a ceramic board and heated in an electric furnace in the atmosphere at 800° C. for two hours, thereby removing components other than the boron nitride particles by heating and decomposition. After that, the particles remaining on the ceramic board are observed with SEM. In a case where the heat dissipation sheet contains an aggregated boron nitride particle, since the aggregated boron nitride particle remains in a lumpy shape (in a state where the aggregated boron nitride particle can be distinguished on a SEM image) on the ceramic board, it is possible to confirm the presence of the aggregated boron nitride particle (the fact that the heat dissipation sheet contains the aggregated boron nitride particle) with a SEM image.

In the cross section of the heat dissipation sheet, the area percentage of the hollow part in the tubular boron nitride particle may be 40% or more, 50% or more, 60% or more, 70% or more or 75% or more. The area percentage of the hollow part in the tubular boron nitride particle may be 90% or less, 80% or less or 75% or less. The area percentage of the hollow part in the tubular boron nitride particle can be obtained by importing a cross-sectional image (SEM image) of the heat dissipation sheet into image analysis software (for example, “Mac-view” manufactured by Mountech Co., Ltd.) and calculating the area percentage from the cross-sectional image of the tubular boron nitride particle in the cross-sectional image.

The maximum length of the tubular boron nitride particle in the heat dissipation sheet may be 80 μm or more, 100 μm or more, 125 μm or more, 150 μm or more, 175 μm or more, 200 μm or more, 225 μm or more, 250 μm or more, 300 μm or more or 350 μm or more from the viewpoint of more easily improving the thermal conductivity of the heat dissipation sheet. The maximum length of the tubular boron nitride particle may be 1000 μm or less, 500 μm or less, 300 μm or less or 250 μm or less.

The maximum length of the tubular boron nitride particle in the heat dissipation sheet means the length of the maximum distance among the straight distances between two arbitrary points on one tubular boron nitride particle when a cross section of the heat dissipation sheet has been observed with a scanning electron microscope (SEM). The maximum length may be measured by importing an observation image (SEM image) of the heat dissipation sheet into image analysis software (for example, “Mac-view” manufactured by Mountech Co., Ltd.).

The aspect ratio of the tubular boron nitride particle in the heat dissipation sheet may be 1.5 or more, 1.7 or more, 2.0 or more, 2.2 or more, 2.5 or more, 3.0 or more, 5.0 or more or 7.0 or more from the viewpoint of more easily improving the thermal conductivity of the heat dissipation sheet. The aspect ratio of the tubular boron nitride particle may be 12.0 or less, 10.0 or less, 9.5 or less, 9.0 or less, 8.0 or less, 7.0 or less, 6.0 or less, 5.0 or less, 4.0 or less, 3.0 or less, 2.8 or less or 2.6 or less. The aspect ratio of the tubular boron nitride particle in the heat dissipation sheet is defined in the same manner as the above-described aspect ratio of the tubular boron nitride particle.

The thickness of the outer shell part of the tubular boron nitride particle in the heat dissipation sheet may be 50 μm or less, 30 μm or less, 15 μm or less, 10 μm or less or 8 μm or less. The thickness of the outer shell part may be 1 μm or more, 3 μm or more or 5 μm or more. The thickness of the outer shell part of the tubular boron nitride particle in the heat dissipation sheet is defined as the average value of the lengths of parts in the outer shell part where a straight line has been drawn when the straight lines have been drawn on a cross section of the tubular boron nitride particle such that the straight distance between two arbitrary points was maximized on an observation image (SEM image) obtained by observing the cross section of the heat dissipation sheet with SEM.

The area percentage of the boron nitride particles (the tubular boron nitride particle and the boron nitride primary particles) in the heat dissipation sheet may be 10% or more, 15% or more or 20% or more from the viewpoint of improving the thermal conductivity of the heat dissipation sheet. The area percentage of the boron nitride particles in the heat dissipation sheet may be 90% or less, 80% or less, 70% or less or 60% or less. The area percentage of the boron nitride particles in the heat dissipation sheet is defined as the average value of the calculated area proportions in 10 cross sections from which the area percentage of the boron nitride particles (excluding the hollow part of the tubular boron nitride particle) in an arbitrary 300 μm×300 μm region in each cross-sectional image has been calculated after cross-sectional images obtained by observing 10 arbitrary cross sections of the heat dissipation sheet with SEM at a magnification of 300 times are imported into image analysis software (for example, “Mac-view” manufactured by Mountech Co., Ltd.).

The orientation index of the boron nitride particles in the heat dissipation sheet may be 7 or more, 8 or more, 9 or more, 10 or more or 11 or more from the viewpoint of easiness in the production of the heat dissipation sheet. The orientation index of the boron nitride particles in the heat dissipation sheet may be 15 or less, 14 or less, 13 or less or 12 or less from the viewpoint of further improving the thermal conductivity of the heat dissipation sheet in the thickness direction. The orientation index may be 7 to 15. The orientation index can be calculated with a peak intensity ratio [I (002)/I (100)] between the (002) plane and the (100) plane of boron nitride that are measured with an X-ray diffractometer.

The kind of the resin in the heat dissipation sheet is the same as the kind of the resin in the composition, but the resin in the heat dissipation sheet may be partially or fully cured. In other words, the heat dissipation sheet may be a semi-cured (B-staged) sheet in which the resin has been partially cured or may be a fully cured (C-staged) sheet in which the resin has been fully cured.

The area percentage of the resin in the heat dissipation sheet may be 10% or more, 20% or more, 30% or more or 40% or more and may be 90% or less, 85% or less or 80% or less. The area percentage of the resin in the heat dissipation sheet is defined as the average value of the calculated area proportions in 10 cross sections from which the area percentage of the resin in an arbitrary 300 μm×300 μm region in each cross-sectional image has been calculated after cross-sectional images obtained by observing 10 arbitrary cross sections of the heat dissipation sheet with SEM at a magnification of 300 times are imported into image analysis software (for example, “Mac-view” manufactured by Mountech Co., Ltd.).

The thickness of the heat dissipation sheet may be, for example, 50 μm or more, 80 μm or more or 100 μm or more and may be 1 mm or less, 800 μm or less, 500 μm or less, 400 μm or less or 200 μm or less.

### EXAMPLES

Hereinafter, the present invention will be specifically described using examples. However, the present invention is not limited only to the following examples.

### Example 1

### [Production of Tubular Boron Nitride Particle]

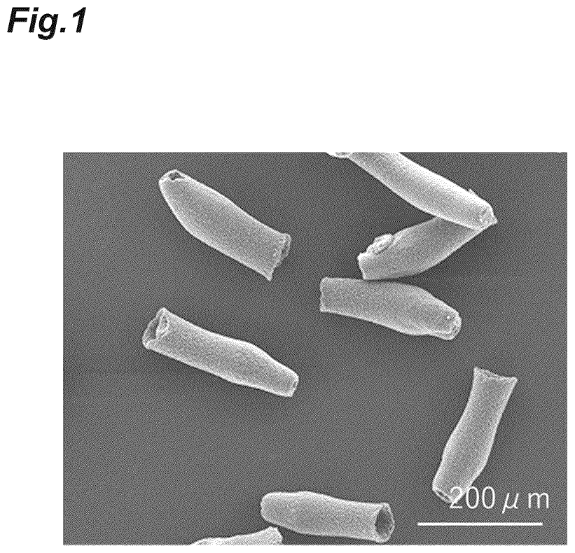

100 Parts by mass of a boron carbide powder having an average particle diameter of 10 μm and 9 parts by mass of boric acid were mixed together, a carbon crucible was filled with the mixture, the open part of the carbon crucible was covered with a carbon sheet (manufactured by NeoGraf Solutions), and the carbon sheet was sandwiched the lid of the carbon crucible and the carbon crucible to fix the carbon sheet. The lidded carbon crucible was heated in a resistance heating furnace in a nitrogen gas atmosphere under conditions of 2000° C. and 0.85 MPa for 20 hours, whereby tubular boron nitride particles were generated on the carbon sheet. A SEM image of the boron nitride particles (tubular boron nitride particles) collected from the carbon sheet is shown in FIG. 1. The boron nitride particles collected from the carbon sheet included tubular boron nitride particles having a maximum length of 200 μm and an aspect ratio of 2.5. The average value of the load intensities at the time of crushing 10 tubular boron nitride particles was 40 mN.

### [Preparation of Powder]

The produced tubular boron nitride particles and aggregated boron nitride particles (crushing strength: 4 MPa and average particle diameter: 35 μm) were mixed together in a volume ratio of 1:15 (=tubular boron nitride particle to aggregated boron nitride particle), thereby fabricating a powder.

### [Fabrication of Heat Dissipation Sheet]

100 Parts by mass of a naphthalene-based epoxy resin (manufactured by DIC Corporation, HP4032) and 10 parts by mass of an imidazole compound (manufactured by Shikoku Kasei Holdings Corporation, 2E4MZ-CN) as a curing agent were mixed together, and the fabricated powder was then further mixed therewith, thereby obtaining a composition. In the obtained composition, the content of the tubular boron nitride particles was 3 vol % based on the total volume of the composition, and the content of the aggregated boron nitride particles was 45 vol % based on the total volume of the composition.

The obtained composition was degassed under reduced pressure of 500 Pa for 10 minutes and applied onto a PET sheet so that the thickness reached 1.0 mm. After that, press heating and pressurization was performed thereon under conditions of a temperature of 150° C. and a pressure of 160 kg/cm² for 60 minutes, thereby fabricating a 0.5 mm heat dissipation sheet.

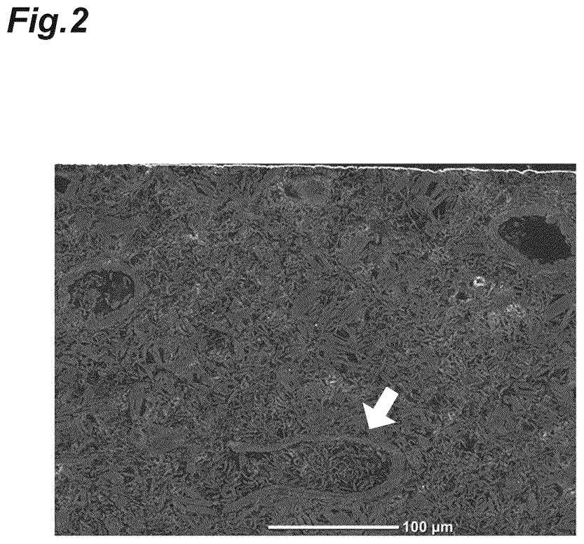

A SEM image of a cross section of the fabricated heat dissipation sheet is shown in FIG. 2. It was possible to confirm that some of a plurality of boron nitride primary particles were located within the tubular boron nitride particles in the cross section of the heat dissipation sheet. For one of the tubular boron nitride particles (a tubular boron nitride particle indicated by an arrow in FIG. 2), the maximum length was 200 μm, the aspect ratio was 2.5, the area percentage of the hollow part in the boron nitride particle was 75% and the thickness of the outer shell part was 5 μm.

### [Measurement of Thermal Conductivity]

A 10 mm×10 mm-size measurement specimen was cut out from the fabricated heat dissipation sheet, and the thermal conductivity (m2/second) of the measurement specimen was measured by a laser flash method in which a xenon flash analyzer (manufactured by NETZSCH, LFA 447 NanoFlash) was used. In addition, the specific gravity B (kg/m3) of the measurement specimen was measured by the Archimedes method. In addition, the specific heat capacity C (J/(kg·K)) of the measurement specimen was measured using a differential scanning calorimeter (manufactured by Rigaku Corporation, Thermo Plus Evo DSC 8230). The thermal conductivity H1 (W/(m·K)) of the heat dissipation sheet of Example 1 was obtained from a formula H1=A×B×C using each of these physical property values.

Separately from the heat dissipation sheet of Example 1, a heat dissipation sheet that was the heat dissipation sheet of Example 1 in which the tubular boron nitride particles were not used (the content of the tubular boron nitride particles was 0 vol %) was prepared, and the thermal conductivity H0 of this heat dissipation sheet was also measured in the same manner as described above. In addition, the ratio (H1/H0) of the thermal conductivity H1 of the heat dissipation sheet of Example 1 to the thermal conductivity H0 of the heat dissipation sheet in which the tubular boron nitride particles were not used was calculated. This ratio indicates the degree of improvement in the thermal conductivity of the heat dissipation sheet (improvement magnification) by the use of the tubular boron nitride particles. The result is shown in Table 1.

### [Measurement of Orientation Index]

Regarding the heat dissipation sheet of the example, the orientation index [I (002)/I (100)] of boron nitride in the heat dissipation sheet was obtained using an X-ray diffractometer (manufactured by Rigaku Corporation, trade name: ULTIMA-IV) to confirm the state of boron nitride in the heat dissipation sheet. Baseline correction was performed by irradiating the heat dissipation sheet set on a specimen holder of the X-ray diffractometer with X rays. After that, the peak intensity ratio between the (002) plane and the (100) plane of the boron nitride was calculated. This was regarded as the orientation index [I (002)/I (100)]. The orientation index of the heat dissipation sheet of Example 1 was 11.13.

### Example 2

Fabrication of a heat dissipation sheet, measurement of the thermal conductivity and measurement of the orientation index were performed in the same manner as in Example 1 except that a powder was fabricated with the volume ratio between the tubular boron nitride particles and the aggregated boron nitride particles changed to 1:9 and the content of the tubular boron nitride particles in the composition was 5 vol % based on the total volume of the composition. In the measurement of the thermal conductivity, the thermal conductivity of the heat dissipation sheet of Example 2 was regarded as H1, and the thermal conductivity of a heat dissipation sheet that was the heat dissipation sheet of Example 2 in which the tubular boron nitride particles were not used (the content of the tubular boron nitride particles was 0 vol %) was regarded as H0. The orientation index of the heat dissipation sheet of Example 2 was 9.49.

### Comparative Example 1

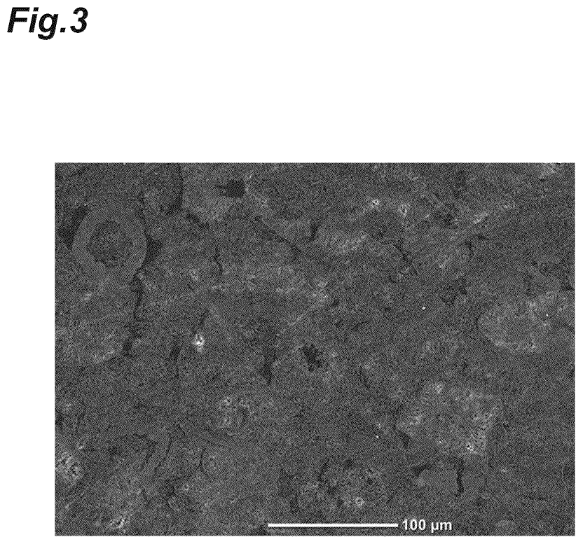

Fabrication of a heat dissipation sheet and measurement of the thermal conductivity were performed in the same manner as in Example 2 except that aggregated boron nitride particles (average particle diameter: 85 μm) having a crushing strength of 7 MPa were used as the aggregated boron nitride particles. A SEM image of a cross section of the fabricated heat dissipation sheet is shown in FIG. 3. In the measurement of the thermal conductivity, the thermal conductivity of the heat dissipation sheet of Comparative Example 1 was regarded as H1, and the thermal conductivity of a heat dissipation sheet that was the heat dissipation sheet of Comparative Example 1 in which the tubular boron nitride particles were not used (the content of the tubular boron nitride particles was 0 vol %) was regarded as H0.

### Comparative Example 2

Fabrication of a heat dissipation sheet and measurement of the thermal conductivity were performed in the same manner as in Example 2 except that aggregated boron nitride particles (average particle diameter: 42 μm) having a crushing strength of 11 MPa were used as the aggregated boron nitride particles. In the measurement of the thermal conductivity, the thermal conductivity of the heat dissipation sheet of Comparative Example 2 was regarded as H1, and the thermal conductivity of a heat dissipation sheet that was the heat dissipation sheet of Comparative Example 2 in which the tubular boron nitride particles were not used (the content of the tubular boron nitride particles was 0 vol %) was regarded as H0.

TABLE 1

| | | | Comparative | Comparative |
|---|---|---|---|---|
| | Example 1 | Example 2 | Example 1 | Example 2 |
| Ratio of | 1.51 | 2.49 | 1.03 | 1.24 |
| thermal | | | | |
| conductivities | | | | |
| (H1/H0) | | | | |

1. A powder comprising:
a tubular boron nitride particle; and
an aggregated boron nitride particle that is an aggregate of a plurality of boron nitride primary particles,
wherein the aggregated boron nitride particle has a crushing strength of less than 7 MPa.

2. The powder according to claim 1,
wherein a content of the tubular boron nitride particle is 2 to 26 vol % based on a total volume of the powder.

3. The powder according to claim 1,
wherein the tubular boron nitride particle comprises a boron nitride particle having a maximum length of 80 μm or more and an aspect ratio of 1.5 or more.

4. The powder according to claim 1,
wherein the tubular boron nitride particle has a strength of 25 mN or more.

5. A method for producing a heat dissipation sheet, the method comprising:
a step of applying a pressure to a composition to form into a sheet shape, wherein the composition comprises a tubular boron nitride particle, an aggregated boron nitride particle that is an aggregate of a plurality of boron nitride primary particles and a resin,
wherein the aggregated boron nitride particle has a crushing strength of less than 7 MPa.

6. A heat dissipation sheet comprising:
a tubular boron nitride particle;
a plurality of boron nitride primary particles; and
a resin,
wherein some of the plurality of boron nitride primary particles is located within the tubular boron nitride particle.

7. The heat dissipation sheet according to claim 6,
having an orientation index of 7 to 15.

8. The heat dissipation sheet according to claim 6,
wherein the tubular boron nitride particle comprises a boron nitride particle having a maximum length of 80 μm or more and an aspect ratio of 1.5 or more.
